(19) United States
(12) Patent Application Publication
(10) Pub. No.: US 2018/0363368 A1
(43) Pub. Date: Dec. 20, 2018

(54) TRANSMISSION CORD TAKE-UP WHEEL FOR WINDOW BLIND

(71) Applicant: SHEEN WORLD TECHNOLOGY CORPORATION, TAICHUNG CITY (TW)

(72) Inventor: Po-Yu CHEN, TAICHUNG CITY (TW)

(21) Appl. No.: 15/870,894

(22) Filed: Jan. 13, 2018

(30) Foreign Application Priority Data
Jun. 20, 2017 (TW) 106120627

(51) Int. Cl. E06B 9/322; E06B 9/68; F16F 15/315

(52) U.S. Cl. CPC E06B 9/322; F16F 15/3156; E06B 9/68

(57) ABSTRACT

A transmission cord take-up wheel used in a window blind is disclosed to include a plastic wheel body including two opposing tooth plates, a tooth plate connection portion connecting the two tooth plates, a tubular shaft disposed in the tooth plate connection portion and an axle hole defined in the tubular shaft, and a bushing press-fitted into the axle hole of the plastic wheel body. Thus, through the arrangement of the bushing, the transmission cord take-up wheel eliminates noises during operation.

### BACKGROUND OF THE INVENTION

### 1. Field of the Invention

The present invention relates to window blind technology, and more particularly to a transmission cord take-up wheel for window blind.

### 2. Description of the Related Art

In a window blind, opening or receiving the slats is operated through multiple transmission cords. When receiving the slats, the transmission cord take-up wheels are driven to rotate by an external force and to simultaneously take up the transmission cords. During rotation of the transmission cord take-up wheels to take up the transmission cords, the bottom rail is lifted to push the slats one after another in an upward direction toward the top rail, enabling the slats to be received to the top rail in a stack.

During the aforesaid slats receiving operation, due to material difference, manufacturing tolerances or wearing problem, noises can be produced between the transmission cord take-up wheel and the wheel axle that supports the transmission cord take-up wheel, causing troubles to the user.

### SUMMARY OF THE INVENTION

The present invention has been accomplished under the circumstances in view. It is the main object of the present to provide a transmission cord take-up wheel for window blind, which eliminates noises during operation.

To achieve this and other objects of the present invention, a transmission cord take-up wheel comprises a plastic wheel body and a bushing. The plastic wheel body comprises two opposing tooth plates, a tooth plate connection portion connecting the two tooth plates, a tubular shaft disposed in the tooth plate connection portion, and an axle hole defined in the tubular shaft. Through the tooth plate connection portion, the plastic wheel body is provided for securing and winding a transmission cord. By means of the tubular shaft, the plastic wheel body is mountable on a wheel axle in a casing of a transmission cord adjustment device. The bushing is press-fitted into the axle hole of the plastic wheel body. Thus, through the arrangement of the bushing, the transmission cord take-up wheel eliminates noises produced between the tubular shaft of the plastic wheel body and the wheel axle of the casing during rotation of the plastic wheel body.

In one embodiment of the present invention, one bushing is used, and the bushing is shaped like a round tube having two opposite ends thereof disposed in flush with respective two opposite ends of the tubular shaft.

In another embodiment of the present invention, the axle hole of the plastic wheel body comprises two opposing circular grooves and a straight hole connected between the two circular grooves. In this embodiment, two bushings are used. These two bushings each comprise a bushing head and a bushing body connected to the bushing head. The bushing heads of the two bushings are respectively engaged in the circular grooves of the axle hole. The bushing bodies of the two bushings are respectively disposed in the straight hole of the axle hole and kept apart from each other without contact.

Further, the bushing can be a metal bushing, a ceramic bushing, or a self-lubricating bushing.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a window blind, illustrating a transmission cord adjustment device installed in a head rail.

FIG. 2 is an exploded view of a transmission cord take-up wheel for window blind in accordance with a first embodiment of the present invention.

FIG. 3 is a sectional assembly view of the transmission cord take-up wheel for window blind in accordance with the first embodiment of the present invention.

FIG. 4 is an exploded view of a transmission cord take-up wheel for window blind in accordance with a second embodiment of the present invention.

FIG. 5 is a sectional assembly view of the transmission cord take-up wheel for window blind in accordance with the second embodiment of the present invention.

### DETAILED DESCRIPTION OF THE INVENTION

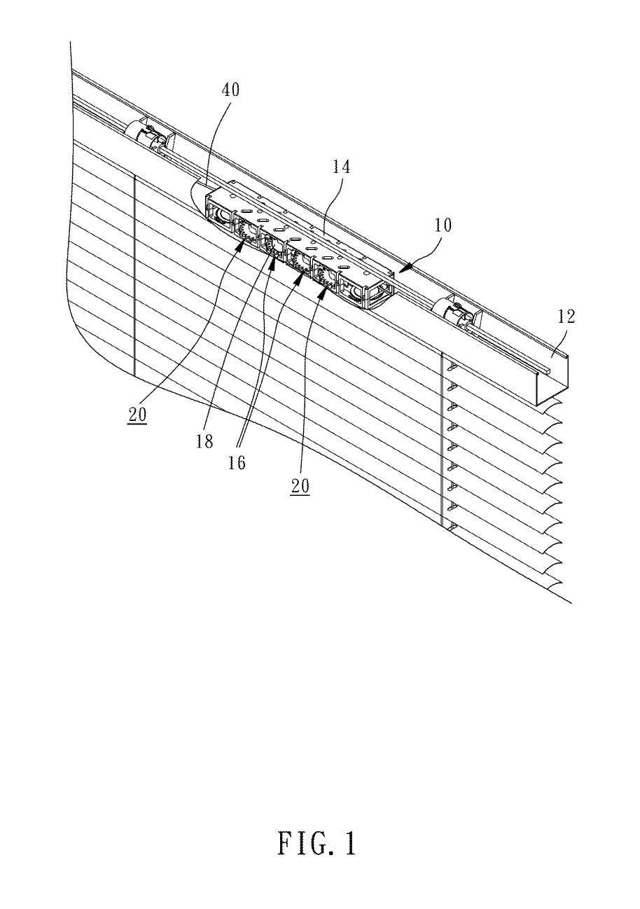

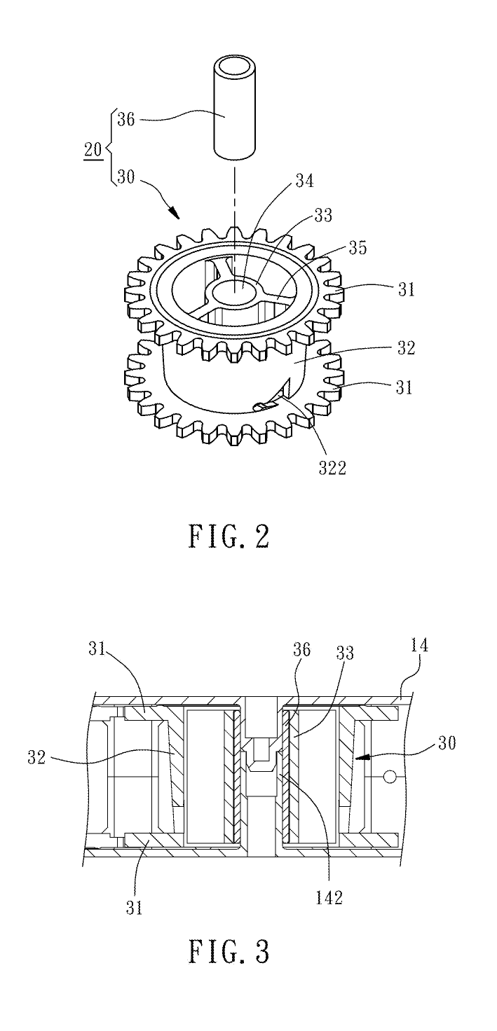

Referring to FIG. 1 and FIG. 2, a transmission cord adjustment device 10 is installed in a top rail 12 of a window blind. The transmission cord adjustment device 10 comprises a casing 14, two coil spring winding gearwheels 16 mounted in the casing 14 at the center and meshed together, and a coil spring 18 connected between the two coil spring winding gearwheels 16. As the transmission cord adjustment device 10 is of the known art, in order to save space, the applicant will not repeat the details of the other components and related action principle of the transmission cord adjustment device 10.

Referring to FIG. 2, a transmission cord take-up wheel 20 in accordance with a first embodiment of the present invention generally comprises a plastic wheel body 30 and a bushing 36.

The plastic wheel body 30 comprises two opposing tooth plates 31 and a hollow tooth plate connection portion 32 connecting the two tooth plates 31. The hollow tooth plate connection portion 32 defines therein a transmission cord mounting hole 322 for the mounting of a transmission cord 40 that has one end thereof inserted through the transmission cord mounting hole 322 and then tied up into knots. Thus, during rotation of the plastic wheel body 30, the transmission cord 40 is wound round the hollow tooth plate connection portion 32 or let off from the hollow tooth plate connection portion 32. The plastic wheel body 30 further comprises a tubular shaft 33, an axle hole 34 axially defined in the tubular shaft 33, and three ribs 35 radially connected between the outer perimeter of the tubular shaft 33 and the inner perimeter of the hollow tooth plate connection portion 32.

The bushing 36 is press-fitted into the axle hole 34 in the plastic wheel body 30. In this embodiment, the bushing 36 is a round tube, having two opposite ends thereof kept in flush with respective two opposite ends of the tubular shaft 33 of the plastic wheel body 30. The bushing 36 can be a metal bushing, ceramic bushing or self-lubricating bushing, which is not particularly limited.

When using the transmission cord take-up wheel 20 in the aforesaid transmission cord adjustment device 10, the bushing 36 of the transmission cord take-up wheel 20 is mounted on a wheel axle 142 in the casing 14 (see FIG. 3), enabling the tooth plates 31 of the plastic wheel body 30 to be meshed with one respective coil spring winding gearwheel 16. Thus, when the transmission cord take-up wheel 20 is driven by the respective winding gearwheel 16 to rotate relative to the casing 14, it simultaneously takes up or lets off the transmission cord 40. At this time, the arrangement of the bushing 36 eliminates noises produced between the plastic wheel body 30 and the wheel axle 142 of the casing 14.

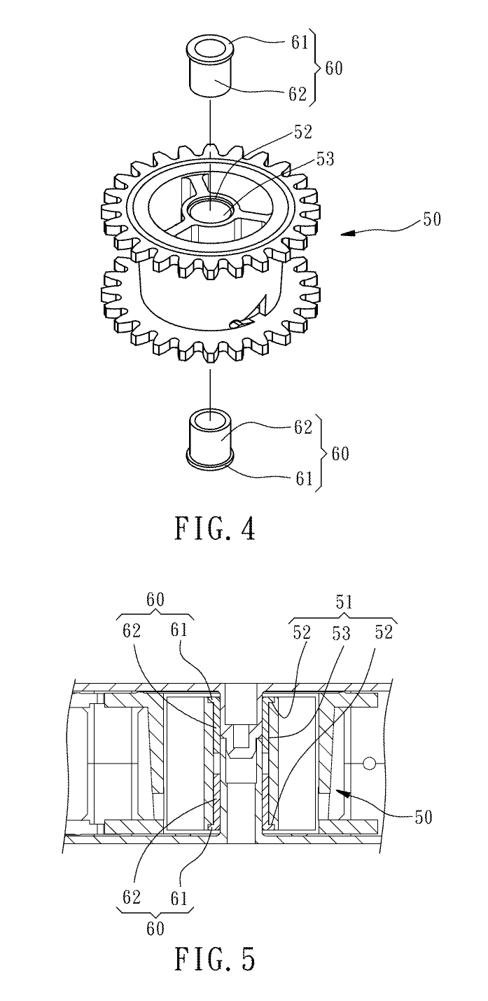

Referring to FIGS. 4 and 5, a transmission cord take-up wheel 20 in accordance with a second embodiment of the present invention is shown. This second embodiment is substantially similar to the aforesaid first embodiment with the exception that the axle hole 51 of the plastic wheel body 50 comprises two circular grooves 52, and a straight hole 53 connected between the two circular grooves 52. The internal diameter of the circular grooves 52 is greater than the internal diameter of the straight hole 53. Further, in this second embodiment, two bushings 60 are used. Each bushing 60 comprises a bushing head 61, and a bushing body connected to the bushing head 61. The bushing head 61 is engaged in one circular groove 52 of the axle hole 51. The bushing body 62 is inserted into the straight hole 53 of the axle hole 51. Further, the distal ends of the bushing bodies 62 of the two bushings 60 are kept apart from each other without contact. Thus, this second embodiment utilizes two bushing 60 disposed in the plastic wheel body 50 in a mirror-symmetrical manner to achieve the effect of eliminating noises.

What is claimed is:

1. A transmission cord take-up wheel used in a window blind, comprising:
a plastic wheel body comprising two opposing tooth plates, a tooth plate connection portion connecting said two tooth plates, a tubular shaft disposed in said tooth plate connection portion, and an axle hole defined in said tubular shaft; and
at least one bushing press-fitted into said axle hole of said plastic wheel body.

2. The transmission cord take-up wheel as claimed in claim 1, wherein the number of said at least one bushing is 1, and the said bushing is shaped like a round tube having two opposite ends thereof disposed in flush with respective two opposite ends of said tubular shaft.

3. The transmission cord take-up wheel as claimed in claim 1, wherein said axle hole of said plastic wheel body comprises two opposing circular grooves and a straight hole connected between said two circular grooves; the number of said at least one bushing is 2, and the two said bushings each comprising a bushing head and a bushing body connected to said bushing head, said bushing head being engaged in one respective said circular groove of said axle hole, said bushing body being disposed in said straight hole of said axle hole.

4. The transmission cord take-up wheel as claimed in claim 3, wherein the said bushing bodies of the said two bushings are kept apart from each other.

5. The transmission cord take-up wheel as claimed in claim 1, wherein said tooth plate connection portion is a hollow member; said plastic wheel body further comprises a plurality of ribs connected between said tooth plate connection portion and said tubular shaft.

6. The transmission cord take-up wheel as claimed in claim 1, wherein said tooth plate connection portion of said plastic wheel body defines therein a transmission cord mounting hole.

7. The transmission cord take-up wheel as claimed in claim 1, wherein said at least one bushing is selected from the group of metal bushings, ceramic bushings and self-lubricating bushings.
